(19) United States
(12) Patent Application Publication
(10) Pub. No.: US 2026/0031521 A1
(43) Pub. Date: Jan. 29, 2026

(54) VEHICLE ANTENNA ASSEMBLY, GLASS ASSEMBLY AND VEHICLE

(71) Applicant: Quectel Wireless Solutions Co., Ltd., Shanghai (CN)

(72) Inventors: Mingjun HANG, Shanghai (CN); Gui LIN, Shanghai (CN)

(73) Assignee: Quectel Wireless Solutions Co., Ltd., Shanghai (CN)

(21) Appl. No.: 19/347,654

(22) Filed: Oct. 1, 2025

Related U.S. Application Data
(63) Continuation of application No. PCT/CN2023/108847, filed on Jul. 24, 2023.

(30) Foreign Application Priority Data
Apr. 3, 2023 (CN) 202310348936.2

(51) Int. Cl. H01Q 1/12; H01Q 1/38; H01Q 1/50

(52) U.S. Cl. CPC H01Q 1/1271; H01Q 1/38; H01Q 1/50

(57) ABSTRACT

A vehicle antenna assembly includes an antenna base film and a transparent antenna unit. The transparent antenna unit is attached to one side of the antenna base film, and the transparent antenna unit includes: a first radiation unit, which is configured to receive and transmit a radio frequency signal; and a second radiation unit, which is arranged spaced apart from the first radiation unit. The second radiation unit is grounded and is configured to tune the resonant frequency of the first radiation unit, such that the first radiation unit meets an impedance matching requirement.

### CROSS-REFERENCE TO RELATED APPLICATIONS

This application is a continuation of International Application No. PCT/CN2023/108847, filed on Jul. 24, 2023, which claims priority to Chinese Patent Application No. 202310348936.2, filed on Apr. 3, 2023. All of the aforementioned applications are incorporated herein by reference in their entireties.

### TECHNICAL FIELD

Embodiments of the present application relate to the technical field of antennas, more specifically to a vehicle antenna assembly, a glass assembly and a vehicle.

### BACKGROUND

In recent years, with the increase in the number of vehicles and users, demands for network bandwidth and transmission rate have also become higher and higher in application scenarios of Internet of Vehicles, such as vehicle-to-vehicle communication and vehicle-to-external communication. As a result, an on-board multiband wideband communication antenna technology has emerged, e.g., a multiple-input multiple-output (MIMO) technology in 4G or 5G. The multiple-input multiple-output antenna technology is widely used in a wireless communication system to increase a channel capacity, increase a communication rate, reduce a communication delay, etc., which requires a high antenna isolation degree between various antennas in a multi-antenna array, but the current arrangement of the vehicle antennas is generally unable to meet the requirement of the antenna isolation degree. At the same time, a metal vehicle body inside a vehicle also has a shielding effect on an electromagnetic signal.

### SUMMARY

Embodiments of the present application provide a vehicle antenna assembly, a glass assembly and a vehicle. Various aspects involved in the embodiments of the present application are introduced below.

In a first aspect, a vehicle antenna assembly is provided, including an antenna base film and a transparent antenna unit. The transparent antenna unit is attached to one side of the antenna base film. The transparent antenna unit includes: a first radiation unit, configured to receive and transmit a radio frequency signal; and a second radiation unit, arranged spaced apart from the first radiation unit. The second radiation unit is grounded and is configured to tune a resonant frequency of the first radiation unit, such that the first radiation unit meets an impedance matching requirement.

As a possible implementation, the first radiation unit is a substantially pentagon bilaterally symmetrical along a first axis. The second radiation unit is a rectangle. The second radiation unit includes two radiation modules. The two radiation modules are both grounded, and are respectively located on two sides of the first radiation unit in a first direction. The first direction is perpendicular to the first axis.

As a possible implementation, a width of the second radiation unit in the first direction is greater than a width of the first radiation unit in the first direction.

As a possible implementation, a range of a ratio of the width of the second radiation unit in the first direction to the width of the first radiation unit in the first direction is 1.1-1.2.

As a possible implementation, the vehicle antenna assembly further includes: a feed adapter board, provided with a first conductive portion and a second conductive portion, wherein the first conductive portion and the second conductive portion are arranged spaced apart, and the first conductive portion and the second conductive portion are respectively connected to the first radiation unit and the second radiation unit through anisotropic conductive films; and a radio frequency cable, wherein one end of the radio frequency cable is connected to the feed adapter board. The radio frequency cable includes: a core wire, connected to the first conductive portion and configured to feed the first radiation unit; and a shielding layer, connected to the second conductive portion, such that the second radiation unit is grounded.

As a possible implementation, the vehicle antenna assembly further includes: a connector, connected to another end of the radio frequency cable, and configured to be connected to a radio frequency chip outside the vehicle antenna assembly, so as to achieve radio frequency communication between the transparent antenna unit and the radio frequency chip.

As a possible implementation, the first radiation unit and the second radiation unit are both of a planar structure formed based on nano-silver.

As a possible implementation, transmittance of both the first radiation unit and the second radiation unit is greater than 80%.

In a second aspect, a glass assembly is provided, including a first glass layer; a second glass layer, arranged opposite the first glass layer; and the vehicle antenna assembly as described in the first aspect or any implementation of the first aspect, wherein one side of the vehicle antenna assembly is bonded to the first glass layer through a first glass layer laminated film, and another side of the vehicle antenna assembly is bonded to the second glass layer through a second glass layer laminated film.

In a third aspect, a vehicle is provided, including the vehicle antenna assembly as described in the first aspect or any implementation of the first aspect or the glass assembly as described in the second aspect.

### BRIEF DESCRIPTION OF THE DRAWINGS

FIG. 1 is a schematic structural diagram of V2X communication provided by an embodiment of the present application.

FIG. 2 is a schematic structural diagram of V2X communication provided by another embodiment of the present application.

FIG. 3 is a schematic structural diagram of a vehicle antenna assembly provided by an embodiment of the present application.

FIG. 4 is a schematic structural diagram of a possible voltage standing wave ratio of a first radiation unit over a full frequency band shown in FIG. 3.

FIG. 5 is a schematic structural diagram of a glass assembly provided by an embodiment of the present application.

FIG. 6 is a schematic structural diagram of a vehicle provided by an embodiment of the present application.

### DETAILED DESCRIPTION OF THE EMBODIMENTS

Technical solutions in embodiments of the present application will be clearly and completely described below in conjunction with accompanying drawings in the embodiments of the present application. Apparently, the described embodiments are only part of the embodiments of the present application, not all of them.

Application scenarios involved in the embodiments of the present application are first introduced.

### Vehicle to Everything (V2X)

V2X may provide a telematics service for relieving traffic congestion, assisting in driving, etc. The telematics service improves practicality, convenience, and safety requirements of a vehicle in a use process by performing two-way communication on positional information, vehicle conditions, road conditions and other data sent by the vehicle, and externally collected map information, traffic information, and weather information. Currently, the V2X technology may be either automotive-related dedicated short range communication (DSRC) as defined in institute of electrical and electronics engineers (IEEE) 802.11p or a cellular V2X (C-V2X) technology based on a cellular mobile communication technology as defined in a 3rd generation partnership project (3GPP). It needs to be noted that the application scenarios of the solutions provided by the embodiments of the present application are not limited to the above two mainstream implementations (DSRC and C-V2X) in the current V2X technology. With the evolution of the technology, other newly emerging implementations of the V2X technology are not beyond a coverage range of the application scenarios of the embodiments of the present application.

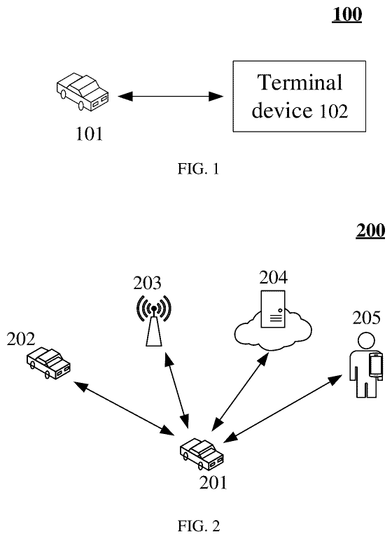

FIG. 1 is a schematic structural diagram of a V2X communication system provided by an embodiment of the present application. As shown in FIG. 1, in some embodiments of the present application, the communication system includes a vehicle 101 and a terminal device 102. The vehicle 101 and the terminal device 102 may be connected through a wireless network.

In some embodiments, the terminal device 102 may be, for example, a handheld device, an on-board device and the like with a wireless connection function. As some specific examples, the terminal device may be a mobile phone, a pad, a laptop, a palmtop, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, or the like. The present application does not impose any particular limitation on a specific form of the terminal device 102. For example, the terminal device 102 may also be a network device, such as a base station.

Specifically, taking a V2X communication system 200 shown in FIG. 2 as an example, vehicle-to-vehicle (V2V) communication between a vehicle 201 and a terminal device 202 involves information interaction between vehicles themselves. Vehicle-to-infrastructure (V2I) communication, vehicle-to-network (V2N) communication, and vehicle-to-pedestrian (V2P) communication between the vehicle 201 and terminal devices 203-205 respectively involve information interaction between the vehicle and external systems.

In recent years, with the increase in the number of vehicles and users, demands for network bandwidth and transmission rate have also become higher and higher in Internet of Vehicles, such as vehicle-to-vehicle communication and vehicle-to-external communication. As a result, an on-board multiband wideband communication antenna technology has emerged, e.g., a multiple-input multiple-output (MIMO) technology in 4G or 5G. The multiple-input multiple-output antenna technology is widely used in a wireless communication system to increase a channel capacity, increase a communication rate, reduce a communication delay, etc., which requires a high antenna isolation degree between various antennas in a multi-antenna array, but the current arrangement of the vehicle antennas is generally unable to meet the requirement of the antenna isolation degree. At the same time, a metal vehicle body inside a vehicle also has a shielding effect on an electromagnetic signal.

As an example, the vehicle antennas may be designed inside a telematics BOX (T-BOX). However, influenced by a circuit design of the T-BOX, an antenna space is squeezed, resulting in a poor antenna isolation degree, and an influence on a performance. In addition, a radio frequency module and its peripheral circuit generate electromagnetic interference, which also affects a receiving and transmitting performance of the antennas. The antennas can only be laid out following the T-BOX, and cannot flexibly avoid a signal shielding area, which directly affects a measured performance of the antennas after an installation on the vehicle.

As another example, the vehicle antennas may be designed inside a shark fin. Due to a limited space of the shark fin, the space inside the shark fin where the antennas are laid out is very constricted, and a problem of an isolation degree between the antennas is also a main factor affecting the performance of the antennas.

As yet another example, the antennas are designed inside on-board diagnostics (OBD). Due to a very small space of the OBD, a problem of an isolation degree between the antennas is also a main factor affecting the performance of the antennas. In addition, the OBD is usually installed in a cab or an engine compartment, and a metal shell of the vehicle also shields an antenna signal seriously.

Therefore, how to provide a vehicle antenna that meets both a vehicle communication demand and an isolation degree demand is an urgent technical problem to be solved.

In view of the above problems, an embodiment of the present application provides a vehicle antenna assembly, including an antenna base film and a transparent antenna unit. The transparent antenna unit is attached to one side of the antenna base film. The transparent antenna unit includes: a first radiation unit, configured to receive and transmit a radio frequency signal; and a second radiation unit, arranged spaced apart from the first radiation unit. The second radiation unit is grounded and is configured to tune a resonant frequency of the first radiation unit, such that the first radiation unit meets an impedance matching requirement. The vehicle antenna assembly in the present solution may be attached to vehicle glass and may also be arranged in a glass interlayer. An antenna design area is large, and a physical distance between antennas is large, such that a problem of an isolation degree between the antennas may be fundamentally solved. In addition, the antennas are designed on the vehicle glass, such that the influence of shielding of metal of a vehicle body on the performance of the antennas may be effectively avoided, thereby greatly improving the radiation efficiency of the antennas.

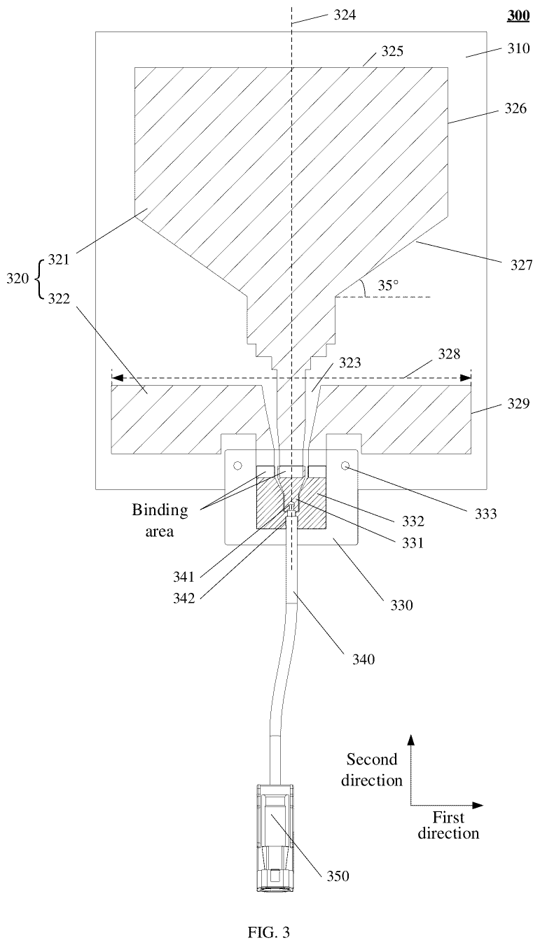

The vehicle antenna assembly in the embodiments of the present application is introduced in detail below in conjunction with FIG. 3. As shown in FIG. 3, the vehicle antenna assembly 300 may include an antenna base film 310 and a transparent antenna unit 320.

In some embodiments, the transparent antenna unit 320 may be attached to one side of the antenna base film 310 in a manner not limited to coating, pasting, or printing, etc. That is to say, the transparent antenna unit 320 may be arranged on a surface of the antenna base film 310. Certainly, in some other embodiments, transparent antenna units may also be arranged on both sides of the antenna base film 310, so that an arrangement area of antennas may be increased, and a throughput rate of sidelink communication data may be improved, which is not specifically limited in the present application.

It needs to be noted that the antenna base film 310 may be formed from a transparent or translucent colloidal material, so that the vehicle antenna assembly may be conveniently arranged on the surface of the vehicle glass or in the vehicle glass without interfering with a view inside the vehicle.

The antenna base film 310 may be a transparent or translucent substrate, which may include, for example, polyethylene terephthalate (PET). In some embodiments, one or more of following materials may also be included: polymethyl methacrylate (PMMA), polystyrene (PS), polycarbonate (PC), polyethylene (PE), etc., so as to improve the hardness and toughness of the antenna base film 310. It may be understood that the antenna base film 310 may also be made of any other material that meets a corresponding functional requirement, which is not specifically limited herein.

The transparent antenna unit 320 may include a first radiation unit 321 and a second radiation unit 322. The first radiation unit 321 may be connected to a feedpoint for radio frequency communication, so as to receive and transmit a radio frequency signal. The second radiation unit 322 is arranged spaced apart from the first radiation unit 321. The second radiation unit 322 may be used for grounding to tune a resonant frequency of the first radiation unit 321, such that the first radiation unit 321 can meet an impedance matching requirement.

It needs to be noted that by grounding the second radiation unit 322, the resonant frequency of the first radiation unit 321 may be tuned, such that the first radiation unit 321 meets the impedance matching requirement. It may be understood that structural dimensions of the first radiation unit 322 may likewise have an impact on impedance of the first radiation unit 322 (examples will be given later in conjunction with specific structural dimensions of the first radiation unit 321 and the second radiation unit 322, which will not be described in detail herein).

It needs to be noted that the transparent antenna unit 320 may be transparent or translucent. In some embodiments, transmittance of the first radiation unit 321 and the second radiation unit 322 may be greater than 75%. In order to avoid the influence of the transparent antenna unit 320 on the view inside the vehicle, in at least one embodiment, the transmittance of the first radiation unit 321 and the second radiation unit 322 may be greater than or equal to 80%.

In some embodiments, the first radiation unit 321 and the second radiation unit 322 which have conductivity may be prepared into specific patterns on the surface of the antenna base film 310, e.g., they may be prepared into polygons, rectangles, etc., and certainly they may be also prepared into irregular patterns, which is not specifically limited in the present application.

In some embodiments, the first radiation unit 321 and the second radiation unit 322 may be of a planar structure. For example, the first radiation unit 321 and the second radiation unit 322 may be planar-structure radiators formed on the surface of the antenna base film 310 by a special fabrication process based on nano-silver. The special fabrication process may include physical preparation or chemical preparation, etc., and specifically may include, but is not limited to, one or more of following methods: an atomization method, a reduction ball milling method, an evaporation condensation method, a photochemical reduction method, etc.

Further, in order to ensure the view inside the vehicle, for example, conductors in the first radiation unit 321 and the second radiation unit 322 may also be formed into thin lines, thus constituting mesh-like planar structures. It may be understood that by arranging the first radiation unit 321 and the second radiation unit 322 into the mesh-like planar structures, the transmittance of the transparent antenna unit 320 may be improved to reduce the obstruction of the view.

The embodiment of the present application does not specifically limit thicknesses of the first radiation unit 321 and the second radiation unit 322. For example, the thicknesses of the first radiation unit 321 and the second radiation unit 322 may be 10 μm-12 μm.

In some embodiments, the first radiation unit 321 and the second radiation unit 322 are arranged spaced apart. A range of a spacing slit 323 between the first radiation unit 321 and the second radiation unit 322 may be 0.2 mm-4 mm. The spacing slit 323 may be set on demand.

In some embodiments, the spacing slit 323 may also have an impact on impedance matching of the first radiation unit 322. In order to more accurately tune a resonant frequency of the first radiation unit 321 such that the first radiation unit 321 meets the impedance matching requirement, referring again to FIG. 3, as a tail radiator of the second radiation unit 322 gradually widens in a second direction, correspondingly, the spacing slit 323 may be set to gradually widen in the second direction.

In some embodiments, the first radiation unit 321 may be a substantially pentagon bilaterally symmetrical along a first axis 324. Accordingly, the second radiation unit 322 may be a rectangle or a substantially rectangle bilaterally symmetrical along the first axis 324. To facilitate the setting of the spacing slit 323, optionally, the second radiation unit 322 may include two radiation modules. The two radiation modules are both grounded, and are respectively located on two sides of the first radiation unit 321 in the first direction. The first direction is perpendicular to the first axis 324.

In some embodiments, a width of the second radiation unit 322 in the first direction is greater than a width of the first radiation unit 321 in the first direction, such that the resonant frequency of the first radiation unit 321 may be effectively tuned to meet the corresponding impedance matching requirement thereof. In at least one embodiment, a range of a ratio of the width of the second radiation unit 322 in the first direction to the width of the first radiation unit 321 in the first direction is 1.1-1.2. For example, the ratio of the width of the second radiation unit 322 in the first direction to the width of the first radiation unit 321 in the first direction may be 1.15. For example, the width 328 of the second radiation unit 322 in the first direction may be 92 mm, and a width of a first side 325 of the first radiation unit 321 in the first direction may be 80 mm.

In some embodiments, a width of a second side 326 of the first radiation unit 321 in the second direction may be 37.80 mm. A side length of a third side 327 of the first radiation unit 321 may be 35 mm. A range of an included angle between the third side 327 of the first radiation unit 321 and the first direction may be 30°-40°. For example, the included angle between the third side 327 and the first direction may be set to 35°. A width of a first side 329 of the second radiation unit 322 in the second direction may be 18 mm.

In one embodiment, impedance of the first radiation unit 321 is approximately 50Ω. It may be understood that, in general, impedance of a coaxial line through which the first radiation unit 321 is connected to the feedpoint is approximately 50Ω. When the impedance of the first radiation unit 321 is the same as the impedance of the coaxial line, the impedance matching requirement can be effectively met, thereby reducing a return loss of the first radiation unit 321, such that the radiation performance of the first radiation unit 321 can meet the corresponding requirement.

It may be understood that since the first radiation unit 321 may generate a resonant frequency signal at the spacing slit 323, such that the second radiation unit 322 may also radiate part of the radio frequency signal, which is not specifically limited in the present application.

In some embodiments, a range of a frequency of the first radiation unit 321 may be 600 MHz-6000 MHz, so as to meet frequency band requirements of multiple standards of 2G GSM, 4G LTE, 5G NR, IOT, CAT-M, NB, WIFI, GNSS, etc.

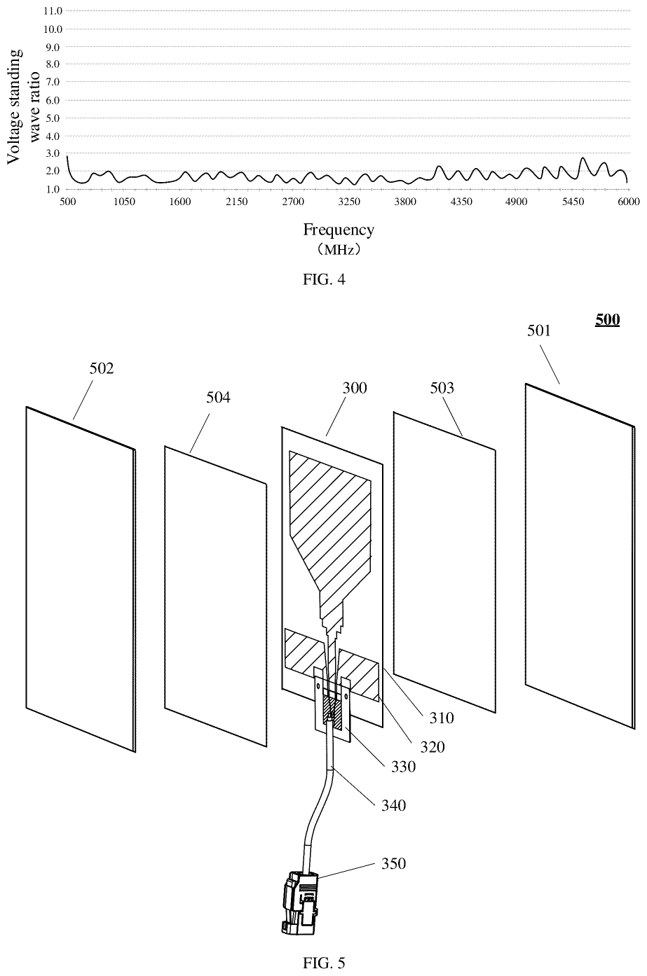

The radiation performance of the first radiation unit 321 is described below in conjunction with FIG. 3 and FIG. 4. The radiation performance of the first radiation unit 321 may be described, for example, by a voltage standing wave ratio (VSWR).

Referring again to FIG. 3, the first radiation unit 321 may be arranged as a substantially pentagon bilaterally symmetrical along the first axis 324. The side length of the first side 325 is 80 mm. The side length of the second side 326 is 37.8 mm. The side length of the third side 327 is 35 mm. The included angle between the third side 327 and the first direction is 35°. The second radiation unit 322 is arranged as a substantially rectangle bilaterally symmetrical along the first axis 324. The width 328 of the second radiation unit 322 in the first direction is 92 mm. The side length of the first side 329 is 18 mm. Based on this, after tuning the resonant frequency of the first radiation unit 321 such that the first radiation unit 321 meets the impedance matching requirements, a voltage standing wave ratio (VSWR) of the first radiation unit 321 over a full frequency band may be obtained by testing, as shown in FIG. 4. It may be seen that the VSWR of the first radiation unit 321 within a range of the full frequency band is less than 3, i.e., the adoption of an architecture of the vehicle antenna assembly in the embodiment of the present application may result in a good impedance matching effect of the first radiation unit 321 and a small reflection loss.

Continuing to refer to FIG. 3, in some embodiments, the vehicle antenna assembly 300 may further include a feed adapter board 330, a radio frequency cable 340, and a connector 350.

The feed adapter board 330 is provided with a first conductive portion 331 and a second conductive portion 332. The first conductive portion 331 and the second conductive portion 332 are arranged spaced apart. The first conductive portion 331 and the second conductive portion 332 may be respectively connected to the first radiation unit 321 and the second radiation unit 322 through anisotropic conductive films (ACFs). The first conductive portion 331 and the second conductive portion 332 may be made of conductive metallic materials, for example, copper and silver, which is not specifically limited in the present application.

In some embodiments, binding areas may be arranged on the first conductive portion 331 and the second conductive portion 332, and binding areas may also be arranged on the first radiation unit 321 and the second radiation unit 322 correspondingly. The first radiation unit 321 and the first conductive portion 331 may be connected through the corresponding ACF in a binding manner in the corresponding binding areas. For example, the ACF may be adopted to achieve a feed connection between the first radiation unit 321 and the first conductive portion 331 through a hot pressing process. Similarly, a binding connection between the second radiation unit 322 and the second conductive portion 332 may also be achieved adopting the corresponding ACF through a hot pressing process. It should be understood that the second conductive portion 332 may be an integral conductive module, or may be arranged as two conductive modules for being connected to the two radiation modules in the second radiation unit 322 correspondingly and respectively.

It may be understood that, in order to facilitate the binding connection, after the binding area is arranged on the second radiation unit 322, the second radiation unit 322 may be a substantially rectangle bilaterally symmetrical along the first axis 324. Certainly, the second radiation unit 322 may also be in an asymmetrical shape.

It needs to be noted that the embodiment of the present application does not impose specific limitations on the set shapes of the first radiation unit 321 and the second radiation unit 322. For example, both the first radiation unit 321 and the second radiation unit 322 may be set in other regular or irregular shapes.

The embodiment of the present application does not impose a specific limitation on the type of the feed adapter board 330. For example, the feed adapter board 330 may be a flexible printed circuit (FPC), a liquid crystal polymer (LCP) board, or a printed circuit board (PCB), etc.

One end of the radio frequency cable 340 may be connected to the feed adapter board 330. The radio frequency cable 340 may include a core wire 341 and a shielding layer 342. The core wire 341 may be connected to the first conductive portion 331 and configured to feed the first radiation unit 321. The shielding layer 342 may be connected to the second conductive portion 332, such that the second radiation unit 322 is grounded, thereby allowing a complete antenna radiation structure to be formed. It may be understood that a connection point of the core wire 341 and the first conductive portion 331 may also be referred to as a feedpoint.

The connector 350 may be connected to another end of the radio frequency cable 340, and configured to be connected to a radio frequency chip (not shown in the figure) outside the vehicle antenna assembly 300, so as to achieve radio frequency communication between the transparent antenna unit 320 and the radio frequency chip. The connector 350 may be, for example, a FAKRA connector, thus being compatible with most radio frequency port connectors on the market, such as FAKRA and SMA.

An embodiment of the present application further provides a glass assembly. The glass assembly in the embodiment of the present application is introduced in detail below in conjunction with FIG. 5. As shown in FIG. 5, the glass assembly 500 may include a first glass layer 501, a second glass layer 502, a first glass layer laminated film 503, a second glass layer laminated film 504, and a vehicle antenna assembly 300.

The first glass layer 501 and the second glass layer 502 are arranged opposite each other. One side of the vehicle antenna assembly 300 (the side close to the first glass layer 501) may be bonded to the first glass layer 501 through the first glass layer laminated film 503. Another side of the vehicle antenna assembly 300 (the side close to the second glass layer 502) may be bonded to the second glass layer 502 through the second glass layer laminated film 504.

In some embodiments, the vehicle antenna assembly 300 may, by adopting a vacuum hot pressing process, be bonded to the first glass layer 501 in a hot pressing manner through the first glass layer laminated film 503 and bonded to the second glass layer 502 in a hot pressing manner through the second glass layer laminated film 504.

In some embodiments, after the feed adapter board 330 is bound to the vehicle antenna assembly 320, a vacuum pot pressing process may be adopted to enable the feed adapter board 330 to be fixed to an inner layer of the glass, so as to enhance pull-out resistance of the feed adapter board 330. In order to better fix the feed adapter board 330, a glue compression hole 333 may be formed in the feed adapter board 330.

In some embodiments, the glass assembly 500 may be, for example, a front windshield, a rear windshield, sunroof glass, or sunshade glass, of a vehicle.

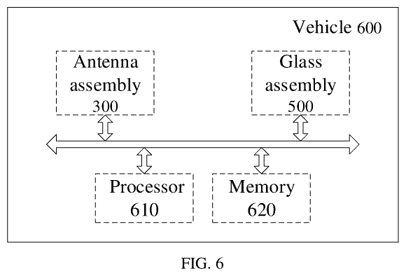

An embodiment of the present application further provides a vehicle. The vehicle in the embodiment of the present application is introduced in detail below in conjunction with FIG. 6. As shown in FIG. 6, the vehicle 600 may include the vehicle antenna assembly 300 or the glass assembly 500 above.

In some embodiments, the vehicle antenna assembly 30 may be pre-fabricated and later attached to glass of the vehicle, which may reduce the difficulty of fabricating the antenna glass and facilitate an installation.

In some embodiments, the glass assembly 500 may also be installed on the vehicle before the vehicle leaves the factory, making the vehicle antenna assembly 300 more stable and mitigating damage caused during a long distance transportation process of the vehicle antenna assembly 300.

According to the above content, it may be seen that the vehicle antenna assembly 300 or the glass assembly 500 provided by the embodiments of the present application flexibly accomplishes a MIMO antenna layout. For example, two antennas may be arranged on a front windshield, two antennas may be arranged on a rear windshield, so as to meet a 4*4 MIMO layout, and a problem of a poor isolation degree between a plurality of antennas in a close distance layout may be fundamentally solved.

In some embodiments, the vehicle 600 may be a small car, a van, etc., which is not specifically limited in the present application.

It may be understood that the vehicle 600 may also include a processor 610. Dotted boxes in FIG. 6 indicate optional options. The processor 610 may be configured to process data from radio frequency communication. The processor 610 may be a general-purpose processor or a specialized processor. For example, the processor 610 may be a central processing unit (CPU). Or, the processor 610 may also be another general-purpose processor, a digital signal processor (DSP), an application specific integrated circuit (ASIC), a field programmable gate array (FPGA) or another programmable logic device, a discrete gate or a transistor logic device, or a discrete hardware component, etc. The general-purpose processor may be a microprocessor, or the processor may also be any conventional processor, etc.

The terminal device 600 may also include one or more memories 620 to store user data. The memory 620 may be independent of the processor 610 or integrated in the processor 610.

In the description of the present application, it needs to be understood that directional or positional relationships indicated by terms “length,” “width,” “thickness,” “inner,”. “outside” and the like are directional or positional relationships shown based on the accompanying drawings, and are only for the convenience of describing the present application and simplifying the description, rather than indicating or implying that an apparatus or element referred to must have a specific orientation and be constructed and operated in a specific orientation, thus cannot be understood as a limitation of the present application.

In addition, terms “first” and “second” are used only for the purpose of description, and cannot be construed as indicating or implying relative importance or implicitly specifying the quantity of indicated technical features. Therefore, a feature restricted by “first” and “second” may explicitly indicate or implicitly include at least one of such features. In description of the present application, “multiple” means at least two, such as two and three, unless it is clearly and specifically defined otherwise.

In the present application, unless otherwise expressly specified and limited, the terms “installation,” “connected,” “connection,” “fixing,” etc. shall be broadly construed, e.g., it may be a fixed connection or a detachable connection or an integral one; it may be a mechanical connection or an electrical connection; it may be a direct connection or an indirect connection through an intermediate medium; and it may be communication within two elements, or an interaction relationship between two elements, unless otherwise expressly limited. To those of ordinary skill in the art, the specific meanings of the above terms in the present application may be understood according to specific circumstances.

In the present application, unless otherwise explicitly specified or defined, the first feature being located “above” or “below” the second feature may be the first feature being in a direct contact with the second feature, or the first feature being in an indirect contact with the second feature through an intermediate medium. In addition, the first feature being “above,” “over,” or “on” the second feature may indicate that the first feature is directly above or obliquely above the second feature, or may merely indicate that a horizontal height of the first feature is greater than that of the second feature. The first feature being “below,” “under,” and “beneath” the second feature may be that the first feature is right below or obliquely below the second feature, or may merely indicate that the horizontal height of the first feature is less than that of the second feature. In the descriptions of this specification, a description referring to terms such as “some embodiments,” “an example,” and “a specific example,” means that a specific feature, structure, material, or characteristic that is described with reference to the embodiment or the example is included in at least one embodiment or example of the present application. In this specification, schematic descriptions of the foregoing terms are not necessarily directed at the same embodiment or example. Besides, the specific features, the structures, the materials or the characteristics that are described may be combined in proper manners in any one or more embodiments or examples. In addition, a person skilled in the art may integrate or combine different embodiments or examples described in the specification and features of the different embodiments or examples in case of no mutual contradiction.

Although the embodiments of the present application have been shown and described above, it can be understood that, the foregoing embodiments are exemplary and should not be understood as limitation of the present application. A person of ordinary skill in the art can make changes, modifications, replacements, or variations to the foregoing embodiments within the scope of the present application.

What is claimed is:

1. A vehicle antenna assembly, comprising an antenna base film and a transparent antenna unit, wherein the transparent antenna unit is attached to one side of the antenna base film, and the transparent antenna unit comprises:
a first radiation unit, configured to receive and transmit a radio frequency signal; and
a second radiation unit, arranged spaced apart from the first radiation unit, wherein the second radiation unit is grounded and is configured to tune a resonant frequency of the first radiation unit, such that the first radiation unit meets an impedance matching requirement.

2. The vehicle antenna assembly according to claim 1, wherein the first radiation unit is a substantially pentagon bilaterally symmetrical along a first axis, the second radiation unit is a rectangle, the second radiation unit comprises two radiation modules, and the two radiation modules are both grounded, and are respectively located on two sides of the first radiation unit in a first direction; and
the first direction is perpendicular to the first axis.

3. The vehicle antenna assembly according to claim 2, wherein a width of the second radiation unit in the first direction is greater than a width of the first radiation unit in the first direction.

4. The vehicle antenna assembly according to claim 3, wherein a range of a ratio of the width of the second radiation unit in the first direction to the width of the first radiation unit in the first direction is 1.1-1.2.

5. The vehicle antenna assembly according to claim 1, further comprising:
a feed adapter board, provided with a first conductive portion and a second conductive portion, wherein the first conductive portion and the second conductive portion are arranged spaced apart, and the first conductive portion and the second conductive portion are respectively connected to the first radiation unit and the second radiation unit through anisotropic conductive films; and
a radio frequency cable, wherein one end of the radio frequency cable is connected to the feed adapter board, and the radio frequency cable comprises:
a core wire, connected to the first conductive portion and configured to feed the first radiation unit; and
a shielding layer, connected to the second conductive portion, such that the second radiation unit is grounded.

6. The vehicle antenna assembly according to claim 1, further comprising:
a connector, connected to another end of a radio frequency cable, and configured to be connected to a radio frequency chip outside the vehicle antenna assembly, so as to achieve radio frequency communication between the transparent antenna unit and the radio frequency chip.

7. The vehicle antenna assembly according to claim 1, wherein the first radiation unit and the second radiation unit are both of a planar structure formed based on nano-silver.

8. The vehicle antenna assembly according to claim 2, wherein the first radiation unit and the second radiation unit are both of a planar structure formed based on nano-silver.

9. The vehicle antenna assembly according to claim 3, wherein the first radiation unit and the second radiation unit are both of a planar structure formed based on nano-silver.

10. The vehicle antenna assembly according to claim 4, wherein the first radiation unit and the second radiation unit are both of a planar structure formed based on nano-silver.

11. The vehicle antenna assembly according to claim 5, wherein the first radiation unit and the second radiation unit are both of a planar structure formed based on nano-silver.

12. The vehicle antenna assembly according to claim 6, wherein the first radiation unit and the second radiation unit are both of a planar structure formed based on nano-silver.

13. The vehicle antenna assembly according to claim 1, wherein transmittance of both the first radiation unit and the second radiation unit is greater than 75%.

14. The vehicle antenna assembly according to claim 2, wherein transmittance of both the first radiation unit and the second radiation unit is greater than 75%.

15. The vehicle antenna assembly according to claim 3, wherein transmittance of both the first radiation unit and the second radiation unit is greater than 75%.

16. The vehicle antenna assembly according to claim 4, wherein transmittance of both the first radiation unit and the second radiation unit is greater than 75%.

17. The vehicle antenna assembly according to claim 5, wherein transmittance of both the first radiation unit and the second radiation unit is greater than 75%.

18. A glass assembly, comprising:
a first glass layer;
a second glass layer, arranged opposite the first glass layer; and
the vehicle antenna assembly according to claim 1, wherein one side of the vehicle antenna assembly is bonded to the first glass layer through a first glass layer laminated film, and another side of the vehicle antenna assembly is bonded to the second glass layer through a second glass layer laminated film.

19. A vehicle, comprising the vehicle antenna assembly according to claim 1.

20. A vehicle, comprising the glass assembly according to claim 18.
